(19) United States
(12) Patent Application Publication
(10) Pub. No.: US 2026/0274095 A1
(43) Pub. Date: Sep. 17, 2026

(54) CHARGING DEVICE AND METHOD FOR OPERATING THE CHARGING DEVICE

(71) Applicant: Robert Bosch GmbH, Stuttgart (DE)

(72) Inventors: Koji Rudolf Jaeger, Kanagawa (JP); Sarang P. Rajamohan, Kerala (IN)

(21) Appl. No.: 18/873,863

(22) PCT Filed: Apr. 25, 2023
(86) PCT No.: PCT/EP2023/060802

§ 371 Date: Dec. 11, 2024

(30) Foreign Application Priority Data
Jun. 28, 2022 (DE) 10 2022 206 477.1

(51) Int. Cl. B60L 53/22; B60L 53/14; H02M 1/10; H02M 1/42; H02M 7/797

(52) U.S. Cl. CPC B60L 53/22; B60L 53/14; H02M 1/10; H02M 1/4216; H02M 7/797; B60L 2210/30

(57) ABSTRACT

A charging device for a vehicle, wherein the charging device (500) has an input-side input terminal unit (100) for connecting a single-phase or three-phase alternating voltage, a PFC stage (200) for providing a direct voltage to an intermediate terminal (300) and a bipolar alternating voltage terminal (400) for providing an alternating voltage.

### BACKGROUND

The invention relates to a charging device and a method for operating the charging device. Furthermore, the invention relates to a drive train with a charging device, a vehicle with a drive train as well as a computer program and a machine-readable storage medium.

Charging devices, for example in vehicles with an electric drive in an electric vehicle or a hybrid vehicle, are used to recharge batteries, preferably accumulators or traction batteries, from an electrical power source, preferably an external AC source or the public AC power supply. To this end, the charging device converts a sinusoidal AC current of the external power source to a DC current. In a single-phase AC current, the power pulses at double the frequency of the AC current.

Preferably, charging devices have two-stage power electronics. A first stage, the so-called power-factor-correction stage, the PFC stage, converts the sinusoidal input voltage from the alternating voltage network into a direct voltage. A second stage consists of a DC voltage converter or DC/DC converter that ensures galvanic isolation via a transformer and adjusts the voltage levels. Preferably, the output voltage and/or the output current for charging the battery is adjusted by means of an electric circuit and a controller. A DC link capacitor is arranged between both stages, buffering the power pulsation at double the frequency of the AC current of the energy source. Typically, this DC link is realized by at least one electrolyte capacitor. These topologies allow for the maintenance of a near sinusoidal input current on the grid side to meet grid-side standards, a galvanic isolation between the grid and vehicle to meet safety requirements, and a provision of a constant DC output current on the side of the battery to minimize the load on the battery during charging.

In an electric drive vehicle, the battery is further connected to an inverter to supply energy to the electric drive machine. A direct voltage converter is connected in parallel to the inverter to supply a low-voltage network, or an on-board power supply, of the vehicle to supply the control units with energy. It is known to generate alternating voltage by means of an inverter connected to the on-board power supply in order to supply an AC socket in the vehicle with energy. The AC socket is provided to operate domestic loads within the vehicle. Domestic loads include, for example, media play equipment, computers, charging devices for mobile devices, coolers, or coffee machines. The resulting plurality of voltage converters within a vehicle is laborious and requires a lot of space within the vehicle. Therefore, there is a need for simple, compact and efficient solutions to provide the plurality of voltages needed.

### SUMMARY

A charging device for a vehicle is provided, wherein the charging device has a, preferably three-phase, input-side input terminal unit for connecting a single-phase to three-phase alternating voltage, a PFC stage for providing a direct voltage to an intermediate terminal, and a bipolar alternating voltage terminal for providing an alternating voltage. The PFC stage comprises a first, a second and a third half-bridge. The first, second, and third half-bridges each comprise a series circuit with a high side switch and a low side switch. In each case, a center tap between the high side switch and the low side switch of a half-bridge can be connected via a first, second and third throttle to a first, second and third input terminal of the, preferably three-phase, input terminal unit via a first, second and third connecting line in each case. Thus, the center tap of the first half-bridge can be connected via the first throttle via the first connecting line to the first input terminal. Thus, the center tap of the second half-bridge can be connected to the second input terminal via the second throttle via the second connecting line. Thus, the center tap of the third half-bridge can be connected to the third input terminal via the third throttle via the third connecting line. The half-bridges are connected in parallel and their ends are connected to the bipolar intermediate terminal. The high side switches are connected to a positive intermediate terminal and the low side switches are connected to a negative intermediate terminal of the bipolar intermediate terminal. The charging device comprises a fourth half-bridge connected in parallel to the first, second, and third half-bridges. The fourth half-bridge comprises a high side switch and a low side switch, wherein a center tap between the high side switch and the low side switch of the fourth half-bridge is switchably connected to a second alternating voltage terminal of the bipolar alternating voltage terminal via a sixth switching element. A fourth switching element, preferably a fourth changeover contact, is provided and configured to establish a connection via the third throttle between the third half-bridge and a first alternating voltage terminal of the bipolar alternating voltage terminal or a connection via the third throttle between the third half-bridge and the third connecting line to the third input terminal. By means of the fourth switching element, the third connecting line can be further advantageously decoupled from the PFC stage and thus from the first and second capacitors. Preferably, the third connecting line is thus only connected to the PFC stage after charging the first and the second capacitors. Preferably, an inrush current is thus prevented when the third connecting line is switched on. Preferably, a pre-charging resistor may be omitted between the third input terminal and the third connecting line.

When operating the bipolar alternating voltage terminal, electrical energy that is present at the intermediate terminal is preferably provided at the bipolar alternating voltage terminal. The electrical power at the intermediate terminal is preferably provided by an external energy source, or the infrastructure, or electric vehicle supply equipment (EVSE), via the input terminal unit and the PFC stage, or by a battery connected to the charging device, preferably a traction battery of the vehicle, via a bi-directional DC/DC converter connected to the intermediate terminal.

To provide a bipolar alternating voltage terminal, on which a controllable alternating voltage can be supplied, a fourth half-bridge is added to a PFC stage of a charging device, the center tap of which is fed to a second alternating voltage terminal. The first alternating voltage terminal is connected to the center tap of a third half-bridge of the PFC stage via a third throttle of the PFC stage. Advantageously, a circuit for a charging device is provided that allows a controllable alternating voltage to be provided at the bipolar alternating voltage terminal. The provision of the alternating voltage may occur during a charging process for charging the battery by means of the charging device. Preferably, the direct voltage at the intermediate terminal is converted into a desired alternating voltage by means of the third and the fourth half-bridge. Preferably, also during the charging process of a battery, voltage and current at the load connected to the bipolar alternating voltage terminal may be influenced by the charging device. Preferably, overloading of the external energy source may be prevented by selectively opening the high side switch and low side switch of the third and fourth half-bridges and thereby shutting down a connected load. Preferably, in the event of a short-circuit, the charging device and/or the connected load can be protected via an overcurrent disconnection.

Preferably, an external source is a single-phase, two-phase or three-phase AC power system, preferably the public low-voltage power system. Preferably, in a North American region or Japanese region, this is a 120 or 240 volt single-phase AC power system.

Preferably, in a Chinese or European region, this is a three-phase AC power system of about 230 volts. To charge the charging device, the charging device is connected to a corresponding AC power system or to the corresponding alternating voltage. Preferably, a battery to be charged is an accumulator or a traction battery by means of which energy is supplied to an electric drive train of a vehicle. A rectification circuit is preferably a rectifier for converting the AC current into a DC current. A high side switch or a low side switch of a semiconductor bridge is preferably a power semiconductor switch comprising an intrinsic diode, preferably an IGBT or MOSFET, preferably based on Si, SiC or GaN technology. Preferably, the expression connecting, for example, a center tap to a connecting line, means contacting or connecting the components by means of an electrically conductive line or a galvanic connection. The expression blocking, preventing, decoupling or preventing a current flow means disconnecting an electrically conductive line or connection. Preferably, the expression switched is used synonymously with electrically connected, wherein switchably connected means that an electrical connection can be established or disconnected, preferably by means of a switch or switching element. Preferably, the expression arranged is used to define the position of an electrical component, preferably a switch or switching element, within the circuit topology, comprising an electrical connection to the adjacent electrical components.

In another configuration, the input terminal unit comprises a neutral conductor terminal. The first to fourth half-bridge is a series circuit of a first and a second diode connected in parallel. The first and second diodes are switched in the blocking direction and prevent, block or prevent a current flow from the positive intermediate terminal to the negative intermediate terminal and allow a current flow from the negative intermediate terminal to the positive intermediate terminal. A center tap between the first and second diode is connected to the neutral conductor terminal via a neutral conductor. A series circuit consisting of a first and a second capacitor is connected in parallel to the half-bridges. Furthermore, a fifth switching element is provided, which is configured to connect the second throttle connected to the second half-bridge on the one hand either to the neutral conductor or to the second connecting line to the second input terminal.

A fifth switching element, preferably a fifth changeover contact, is arranged between the second throttle and the second connecting line. Depending on the switch position, the second throttle is thus connected to the neutral conductor or the second connecting line to the second input terminal. Advantageously, a possibility is created to provide an alternating voltage at the input terminal unit at the first input terminal and the neutral conductor terminal. Preferably, a direct voltage is converted to a desired alternating voltage at the intermediate terminal by means of the first and the second half-bridge and is provided as alternating voltage at the first input terminal and the neutral conductor terminal. The electrical energy at the intermediate terminal is preferably provided by a battery connected to the charging device, preferably a traction battery of the vehicle, via a bi-directional DC/DC converter connected to the intermediate terminal.

In another embodiment of the invention, the second connecting line is divided into a first part of the second connecting line and a second part of the second connecting line. A second switching element is provided, which is arranged between the first part of the second connecting line and the second part of the second connecting line, and is configured to conduct a charging current from the second input terminal via the first part and the second part of the second connecting line to the second throttle, or to conduct a charging current from the first connecting line to the second throttle via the second part of the second connecting line.

A second switching element, preferably a second changeover contact, is arranged between a first part of the second connecting line and a second part of the second connecting line. Depending on the switch position of the second switching element, a charging current is thus conducted from the second input terminal via the first part and the second part of the second connecting line to the second throttle or a charging current is conducted from the first connecting line via the second part of the second connecting line to the second throttle. Advantageously, a possibility is created to partially branch off a single-phase charging current flowing via the first connecting line and to conduct it via the second part of the second connecting line to the second throttle and second half-bridge. Thus, the load on the first throttle and the first half-bridge, preferably in the presence of a single-phase charging current, can be reduced. Preferably, there is a single-phase charging current when a single-phase alternating voltage is connected to the input terminal. By means of the second switching element, the first part of the second connecting line can be further advantageously decoupled from the PFC stage and thus from the first and second capacitors. Preferably, the first part of the second connecting line is thus only connected to the PFC stage after charging the first and the second capacitors. Preferably, an inrush current is thus prevented when the first part of the second connecting line is switched on. Preferably, a pre-charging resistor may be omitted between the second input terminal and the first part of the second connecting line. Preferably, due to the configuration of the second switching element as a second changeover contact, a short circuit between the first connecting line and the first part of the second connecting line is prevented. Preferably, a short circuit between the first input terminal and the second input terminal would be possible by means of a simple switching element that is actuated incorrectly; by means of a second changeover contact, this fault can be reliably ruled out during actuation.

In another configuration, a first switching element is provided and is configured to allow or interrupt a current flow between the first input terminal and the first connecting line or the first throttle of the PFC stage.

A first switching element is arranged between the first connecting line and the first input terminal. Depending on the switch position, a current flow or a charging current from the first input terminal towards the first throttle of the PFC stage is thus enabled or prevented. Advantageously, a possibility is created to interrupt or switch on a charging current via the first connecting line. Preferably, a thermistor or NTC resistor is connected in parallel to the first switching element, which is used to limit an inrush current. Preferably, the inrush current flows from the first input terminal via the PFC stage into the first and/or second capacitor. Preferably at low temperatures, the resistance of the thermistor is high and decreases the inrush current. After switching on, the thermistor heats up due to the current flow and loses its high initial resistance. Preferably, to reduce the losses of the thermistor, it is bridged by closing the first switching element when the first and/or second capacitor is substantially charged.

In another configuration, a third switching element is provided and is configured to allow or interrupt a current flow between the third input terminal and the third connecting line or the third throttle of the PFC stage.

A third switching element is arranged between the third connecting line and the third input terminal. Depending on the switch position, a current flow or a charging current from the third input terminal towards the third throttle of the PFC stage is thus enabled or prevented. Advantageously, a possibility is created to interrupt or switch on a charging current, preferably in the presence of a three-phase charging current, via the third connecting line. Preferably, a thermistor or NTC resistor is connected in parallel to the third switching element, which is used to limit an inrush current. Preferably, the inrush current flows from the third input terminal via the PFC stage into the first and/or second capacitor. Preferably at low temperatures the resistance of the thermistor is high and decreases the inrush current. After switching on, the thermistor heats up due to the current flow and loses its high initial resistance. Preferably, to reduce the losses of the thermistor, it is bridged by closing the third switching element when the first and/or second capacitor is substantially charged.

In another embodiment, a seventh switching element is arranged between the center tap between the first and second diodes and a center tap between the first and second capacitors.

A seventh switching element is connected between the center tap of the first and the second diode and the center tap between the first and the second capacitor. Depending on the switch position, a current flow between the center taps of the diode series circuit and the capacitor series circuit is thus enabled or prevented. Advantageously, a possibility is created to interrupt or switch on a current flow, preferably in the presence of a two-phase or three-phase charging current, between the center tap between the first and the second diode and the center tap between the first and the second capacitor. Preferably, the seventh switching element is closed for operation of the charging device with asymmetrical loading. An asymmetric load is present in the case of operation with a 2-phase network or also with an asymmetric load in the case of operation with a 3-phase network, i.e., two-phase or three-phase alternating voltage. In these cases, the resulting current flows on the neutral conductor via the closed seventh switching element. With a symmetrical load, the alternating voltages on the first, second and third connecting lines are the same and the phase shift between the alternating voltages is 120 degrees in each case. In this case, the sum of the phase currents and the resulting current on the neutral conductor is equal to zero. With an asymmetrical load, the alternating voltages on the first, second and third connecting lines are not all the same and/or the phase shift between the alternating voltages is not 120 degrees in each case. In this case, the sum of the phase currents and the resulting current is not equal to zero. Preferably, when the switching element is closed, a current flow for this total current via the neutral conductor to the neutral conductor terminal is enabled.

In another embodiment, to provide electrical energy to the bipolar alternating voltage terminal, a direct voltage supplied at the positive intermediate terminal and at the negative intermediate terminal is at least partially provided as an alternating voltage at the first alternating voltage terminal and at the second alternating voltage terminal, wherein the fourth switching element establishes a connection from the center tap of the third half-bridge via the third throttle to the first alternating voltage terminal and the sixth switching element establishes a connection from the center tap of the fourth half-bridge to the second alternating voltage terminal.

Advantageously, the fourth and the sixth switching elements are switched in such a way that a controllable alternating voltage is provided at the bipolar alternating voltage terminal. The direct voltage at the intermediate terminal is converted into a desired alternating voltage by means of the third and the fourth half-bridge, preferably by means of filtering via the third throttle and a fourth capacitor between the first and the second alternating voltage terminal. Thus, the third and the fourth half-bridges act as an inverter to generate a, preferably single-phase, alternating voltage from a direct voltage on the bipolar alternating voltage terminal.

In another configuration, to provide electrical energy at the intermediate terminal,
either an alternating voltage supplied to the input terminal unit is provided via the PFC stage at least partially as direct voltage at the positive intermediate terminal and at the negative intermediate terminal, wherein a charging current is conducted via at least the first connecting line and the second connecting line, or at least the second part of the second connecting line, via the PFC stage to the intermediate terminal and preferably the entire charging current is fed back via the neutral conductor,
or a direct voltage provided by a bi-directional direct voltage converter connected to the intermediate terminal and a battery connected to it, preferably a traction battery, is provided at the positive intermediate terminal and at the negative intermediate terminal, wherein the bi-directional direct voltage converter converts the voltage of the battery to the direct voltage to be provided at the positive intermediate terminal and the negative intermediate terminal.

Advantageously, a topology is provided that allows a direct voltage to be provided at the intermediate terminal, wherein the power for this can be provided from an external power source or from a battery, preferably within the vehicle.

In one embodiment, the charging device is configured to provide an alternating voltage at the input terminal unit at the first input terminal and the neutral conductor terminal, wherein, to provide electrical energy at the first input terminal and at the neutral conductor terminal, a direct voltage provided at the positive intermediate terminal and the negative intermediate terminal is at least partially provided as an alternating voltage at the first input terminal and at the neutral conductor terminal, wherein a current between the positive intermediate terminal and the first input terminal is conducted via the first throttle and a current between the negative intermediate terminal and the neutral conductor terminal is conducted via the second throttle.

Advantageously, a topology is provided that allows a provision of an alternating voltage at the first input terminal and the neutral terminal, wherein the energy for this is provided by a battery, preferably within the vehicle.

Furthermore, the invention relates to a drive train of a vehicle with a charging device as described above, wherein the drive train comprises in particular a traction battery, an inverter and/or an electric machine. Advantageously, a drive train of an electric vehicle is provided with a charging device having a simplified circuit topology.

The invention further relates to a vehicle having a drive train, as described above.

Advantageously, a vehicle having a charging device with a simplified circuit topology is provided.

The invention further relates to a method for operating a charging device as presented above with the step of: controlling the fourth and the sixth switching elements as well as the high-side and low-side switches of the third and fourth half-bridges for providing electrical energy to the bipolar alternating voltage terminal.

By controlling the switches of the third and fourth half-bridges and closing the fourth and sixth switching elements, a direct voltage applied to the intermediate terminal is converted into an alternating voltage that is applied to the bipolar alternating voltage terminal. Advantageously, a method is provided that allows a controllable alternating voltage to be provided at the bipolar alternating voltage terminal.

The invention further relates to a computer program comprising commands which, when the program is executed by a computer, prompt the latter to perform the method steps according to the invention.

The invention furthermore relates to a computer-readable memory medium comprising commands which, when executed by a computer, prompt the latter to perform the method steps described hereinabove.

It is understood that the features, properties, and advantages of the charging device apply or can be applied accordingly to the method or the drive train and the vehicle and vice versa.

Further features and advantages of embodiments of the invention are apparent from the following description with reference to the accompanying drawings.

### BRIEF DESCRIPTION OF THE DRAWINGS

The invention will be explained in further detail hereinafter with reference to the drawings:

FIG. 1 a schematic representation of an embodiment of a circuit topology for a charging device known from the prior art

FIG. 2 a schematic representation of a first embodiment of a circuit topology for a charging device,

FIG. 3 a schematic representation of an exemplary current or energy flow in a first operation mode of the circuit topology for a charging device,

FIG. 4 a schematic representation of an exemplary current or energy flow in a second operation mode of the circuit topology for a charging device

FIG. 5 a schematic representation of an exemplary current or energy flow in a third operation mode of the circuit topology for a charging device

FIG. 6 a schematic illustration of a vehicle with a drive train having a charging device,

FIG. 7 a schematic flow chart for a method for operating a charging device

### DETAILED DESCRIPTION

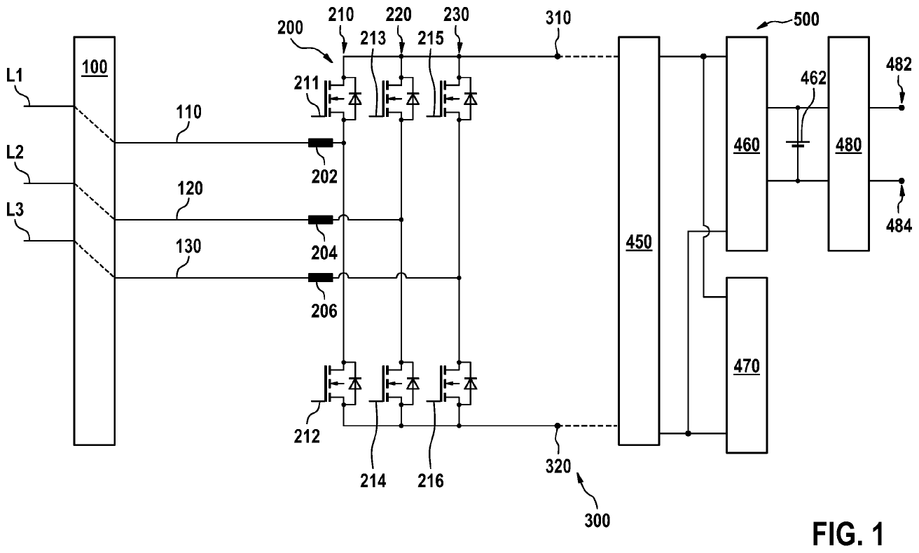

FIG. 1 shows a charging device 500, preferably for a vehicle. The charging device 500 comprises an input-side input terminal unit 100 for connecting a single-phase to three-phase alternating voltage and a PFC stage 200 for providing a direct voltage to an intermediate terminal 300. The PFC stage 200 of the charging device 500 comprises a first 210, a second 220, and a third 230 half-bridge. The first, second, and third half-bridges 210, 220, 230 each comprise a series connection having a high side switch 211, 213, 215 and a low side switch 212, 214, 216. In each case, a center tap between the high side switch and the low side switch of a half-bridge can be connected via a first, second and third throttle 202, 204, 206 to a first, second and third input terminal L1, L2, L3 of the input terminal unit 100 via a first, second and third connecting line 110, 120, 130 in each case. Thus, the center tap of the first half-bridge 210 can be connected via the first throttle 202 via the first connecting line 110 to the first input terminal L1. Thus, the center tap of the second half-bridge 220 can be connected to the second input terminal 120 via the second throttle 204 via the second connecting line L2. Thus, the center tap of the third half-bridge 230 can be connected to the third input terminal 130 via the third throttle 206 via the third connecting line L3. The half-bridges 210, 220, 230 are connected in parallel. Their ends are connected to the bipolar intermediate terminal 300. The high side switches are connected to a positive intermediate terminal 310 and the low side switches are connected to a negative intermediate terminal 320. Preferably, a direct voltage converter 450 is connected to the intermediate terminal 300. The direct voltage at the intermediate terminal 300, which is applied to the input side of the direct voltage converter 450, is preferably converted into a charging voltage for charging a battery 470, preferably a traction battery or a high-voltage battery, which can be connected to the output side of the direct voltage converter 450. Preferably, a further direct voltage converter 460, preferably a step-down converter, is connected in parallel with the battery 470 to convert the charging voltage into a low-voltage voltage for charging a low-voltage battery 462 and to supply an on-board power supply of a vehicle to supply control devices of a vehicle. The low-voltage battery 462, and preferably other low-voltage loads not shown, are connected to the vehicle's on-board power supply. Preferably, the further direct voltage converter 460 is a bi-directional direct voltage converter. Preferably, the further direct voltage converter 460 may be used to pre-charge the high-voltage intermediate circuit before the battery 470 is connected to the charging device 500. The high-voltage intermediate circuit is connected to the direct voltage converter 450 on the output side. Preferably, an inverter 480 is connected to the on-board power system, which converts the low-voltage voltage into an alternating voltage for domestic loads. Preferably, domestic loads are supplied with an alternating voltage, which, depending on the region, is approximately 120 volts or 230-240 volts. To this end, alternating voltage loads can be connected to the first terminal 482 and the second terminal 484.

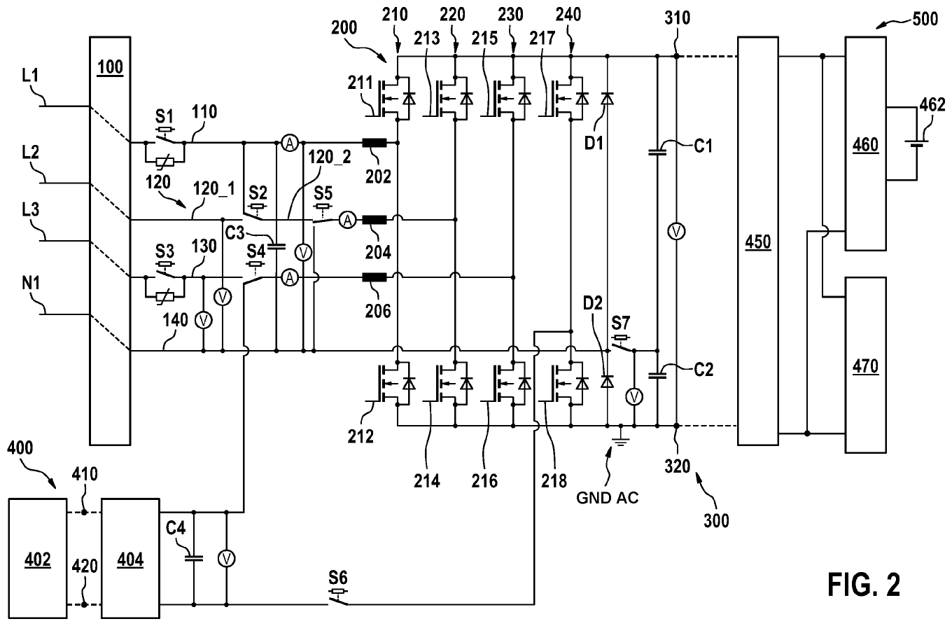

Based on the charging device 500 according to FIG. 1, the charging device 500 according to the invention according to FIG. 2 comprises a bipolar alternating voltage terminal 400. To provide an alternating voltage at the alternating voltage terminal 400, the charging device 500 comprises a fourth half-bridge 240, which is connected in parallel with the first, second and third half-bridge 210, 220, 230, having a high side switch 217 and a low side switch 218, wherein a center tap between the high side switch and the low side switch of the fourth half-bridge 240 is switchably connected to a second alternating voltage terminal 420 of the bipolar alternating voltage terminal 400 via a sixth switching element S6, and wherein a fourth switching element S4 is provided, which is configured to establish a connection via the third throttle 206 between the third half-bridge 230 and a first alternating voltage terminal 410 or a connection via the third throttle 206 between the third half-bridge 230 and the third connecting line 130 to the third input terminal L3. Preferably, the bipolar alternating voltage terminal is configured to supply domestic loads during operation. Preferably, domestic loads are supplied with an alternating voltage, which, depending on the region, is approximately 120 volts or 230-240 volts.

Preferably, the input terminal unit 100 further comprises a neutral conductor terminal N1. A series connection of a first diode D1 and a second diode D2 is connected in parallel to the half-bridges 210, 220, 230, 240. The first and second diodes D1, D2 are switched in the blocking direction and prevent a current flow from the positive intermediate terminal 310 to the negative intermediate terminal 320 and allow a current flow from the negative intermediate terminal 320 to the positive intermediate terminal 310. A center tap between the first and the second diodes D1, D2 is connected to the neutral conductor terminal N1 via a neutral conductor 140. A series circuit consisting of a first C1 and a second C2 capacitor is connected in parallel to the half-bridges 210, 220, 230, 240. A fifth switching element S5 is provided and configured to connect the second throttle 204 connected to the second half-bridge 220 on the one hand either to the neutral conductor 140 or to the second connecting line 120 to the second input terminal L2.

Preferably, the second connecting line 120 is divided into a first part of the second connecting line 120_1 and a second part of the second connecting line 120_2. A second switching element S2 is provided for this purpose, which is arranged between the first part of the second connecting line 120_1 and the second part of the second connecting line 120_2. The second switching element S2 is configured to conduct a charging current from the second input terminal L2 via the first part and the second part of the second connecting line 120_1, 120_2 to the second throttle 204 or to conduct a charging current from the first connecting line 110 via the second part of the second connecting line 120_2 to the second throttle 204.

Preferably, a first switching element S1 is provided and is configured to allow or interrupt a current flow between the first input terminal L1 and the first connecting line 110.

Preferably, a third switching element S3 is provided and is configured to allow or interrupt a charging current between the third input terminal L3 and the third connecting line 130.

Pre-charging resistors, preferably switchable resistors, thermistors or NTC resistors, are preferably connected in parallel with the first S1 and the third S3 switching element, so that an inrush current decays and is limited when an alternating voltage is connected to the input terminal unit 100 before the first and third switching elements S1, S3 are closed.

Preferably, a seventh switching element S7 is arranged between the center tap between the first and the second diode D1, D2 and a center tap between the first and the second capacitors C1, C2.

Preferably, a current sensor (A) is arranged on each of the first, second, and third throttles 202, 204, 206 to determine the current through the respective throttles 202, 204, 206. Depending on the determined currents, preferably the high side switches and the low side switches as well as the switching elements are controlled to implement the desired operation modes. Preferably, voltage sensors (V) are arranged between the first, the second and the third connecting lines 110, 120, 130 and the neutral conductor 140 to determine the voltages. Preferably, a voltage sensor (V) is also arranged between the positive and negative intermediate terminals 310, 320, as well as between the center tap between the first and second capacitors C1, C2 and the negative intermediate terminal 320. Depending on the determined voltages, preferably the high side switch and the low side switch as well as the switching elements are controlled to implement the desired operation modes. Preferably, the negative intermediate terminal 320 is connected to ground GND AC. Preferably, GND AC is an internal voltage potential.

Preferably, the switching elements are provided as semiconductor switch components (IGBT or MOSFETS, based on Si, SiC or GaN) or as contactors or relays.

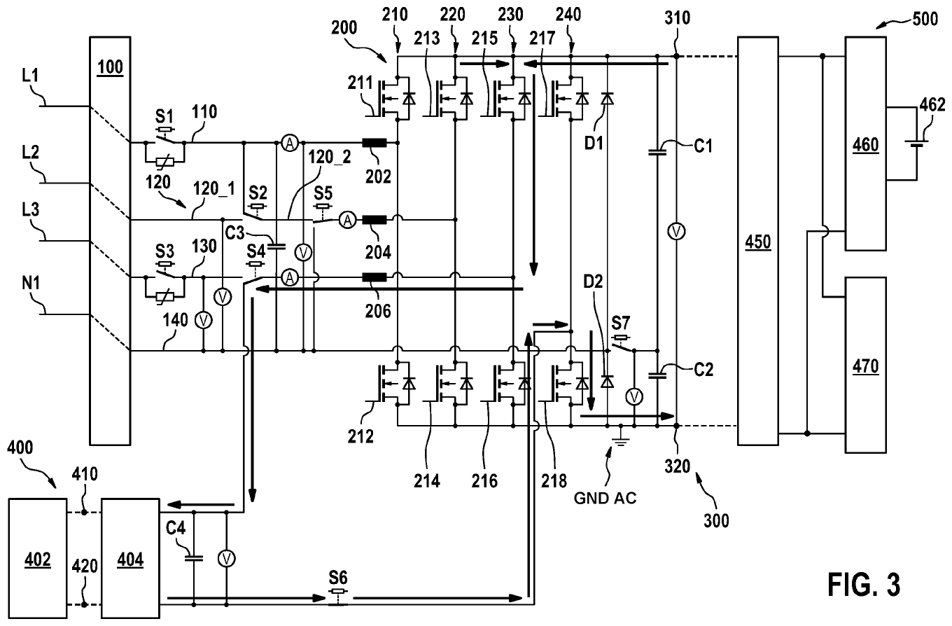

FIG. 3 shows a schematic representation of an exemplary current or energy flow in a first operation mode of the circuit topology for a charging device 500. Preferably, to provide electrical energy at the bipolar alternating voltage terminal 400, a direct voltage supplied at the positive intermediate terminal 310 and the negative intermediate terminal 320 is at least partially provided as alternating voltage at the first alternating voltage terminal 410 and the second alternating voltage terminal 420. Preferably, the fourth switching element S4 establishes a connection from the center tap of the third half-bridge 230 via the third throttle 206 to the first alternating voltage connection 410, and the sixth switching element S6 establishes a connection from the center tap of the fourth half-bridge 240 to the second alternating voltage terminal 420. Consequently, the current profile shown in FIG. 3 results from the positive intermediate terminal 310 via the third half-bridge 230 and the third throttle 206 via the fourth switching element S4, preferably via a filter 404, preferably an EMV filter, to the first alternating voltage connection 410 and from the second alternating voltage connection 420 via the closed switching element S6 back via the fourth half-bridge 240 to the negative intermediate terminal 320. Preferably, a fourth capacitor C4 between the first alternating voltage terminal 410 and the second alternating voltage terminal 420 filters the alternating voltage to be provided in a supporting manner. In summary, a provision of electrical energy is enabled at the bipolar alternating voltage terminal 400. This bipolar alternating voltage terminal 400 is preferably provided by means of a socket, either inside or outside the vehicle, preferably for supplying connected, preferably domestic, loads 402. The electrical energy at the intermediate terminal 300 may be provided by an energy source connected to the single-phase to three-phase input terminal and/or a battery 470, preferably connected via the direct voltage converter 450. For this purpose, the direct voltage converter 450 is configured as a bi-directional direct voltage converter. The direct voltage converter 450 converts the direct voltage of the battery 470 into the desired direct voltage at the intermediate terminal 300.

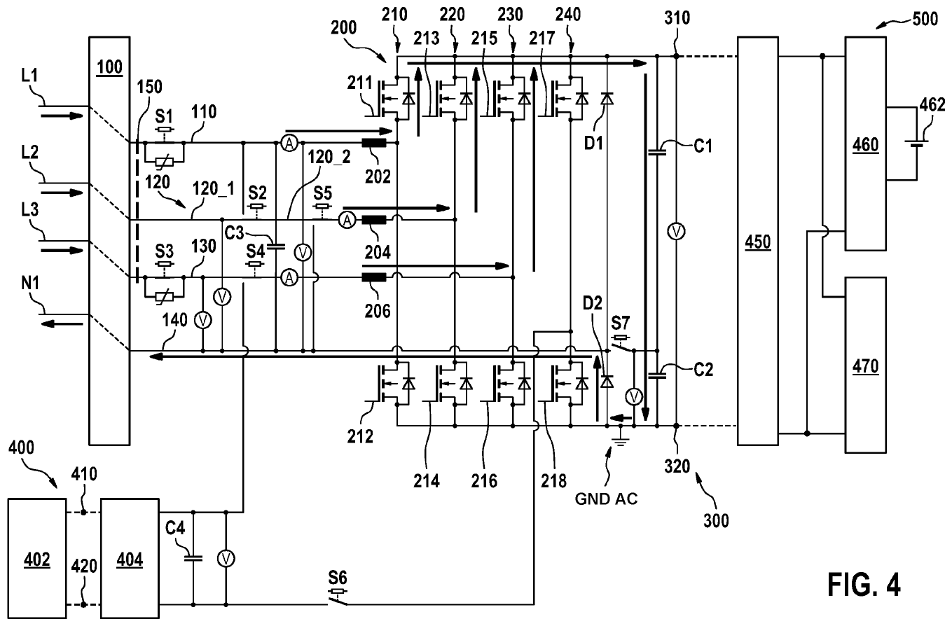

FIG. 4 shows a schematic representation of an exemplary current or energy flow in a second operation mode of the circuit topology for a charging device. Preferably, to provide electrical energy to the intermediate terminal 300, an alternating voltage supplied to the input terminal unit 100 via the PFC stage 200 is provided at least partially as a direct voltage at the positive intermediate terminal 310 and the negative intermediate terminal 320. Preferably, a charging current is conducted via at least the first connecting line 110 and the second connecting line 120, or at least the second part of the second connecting line 120_2, via the PFC stage 200 to the intermediate connection 300. Preferably, the total charging current is filtered over the first and second capacitors C1, C2 and fed back to the neutral conductor terminal N1 via the diode D2 and neutral conductor 140. Preferably, a three-phase alternating current from a three-phase alternating voltage source connected to the input terminal unit is conducted to the intermediate terminal via all three connection lines 110, 120, 130 with the first and third switching elements S1 S3 closed via the first, second and third throttles 202, 204, 206. Preferably, a three-phase alternating current from a three-phase alternating voltage source connected to the input terminal unit is conducted via the first and second connecting lines 110, 120 to the intermediate terminal via the first and second throttles 202 and 204 when the first switching element S1 is closed and the third S3 switching element is open. Due to the resulting asymmetric load on the charging device 500, the connection between the center tap of the series connection of the first and the second capacitor C1, C2 and the center tap of the series connection of the first and the second diode D1, D2 is preferably closed by means of the switching element S7. The closed switching element S7 allows an alternative path for returning the charging current, or the resulting current, via the neutral conductor 140. Preferably, a single-phase alternating current from a single-phase alternating voltage source connected to the input terminal unit is conducted between the first, second and third input terminal L1, L2, L3 via all three connecting lines 110, 120, 130 with the first and third switching elements S1 S3 closed via the first, second and third throttles 202, 204, 206 to the intermediate terminal by means of a bridge 150, a galvanic connection. Preferably, a single-phase alternating current from a single-phase alternating voltage source connected to the input terminal unit is conducted between the first, second and third input terminal L1, L2, L3 via the first and the second connecting line 110, 120, with the first switching element S1 closed and the third switching element S3 open via the first and second throttle 202 and 204 to the intermediate terminal by means of a bridge 150, a galvanic connection. Preferably, the bridge 150 is used in charging devices 500 that are used in regions around the world where the infrastructure and the public power grid only provide single-phase alternating voltage sources as external alternating voltage sources. Preferably, a single-phase alternating current from a single-phase alternating voltage source connected to the first input terminal L1 of the input terminal 100 is conducted by means of the second switching element S2 via the first connecting line 110 and the second part of the second connecting line 120_2 via the first and second throttles 202 and 204 to the intermediate terminal when the first switching element S1 is closed. In summary, different options of providing electrical energy are provided at the intermediate terminal 300. These different options correspond to the current profile during a charging operation in which energy from an external energy source connected to the input terminal 100 is transferred to the intermediate terminal 300. Preferably, the second operation mode is performed alone. In the options of the second operation mode with the switching element S3 open, the first operation mode, the provision of electrical energy at the bipolar alternating voltage terminal 400, is preferably performed simultaneously.

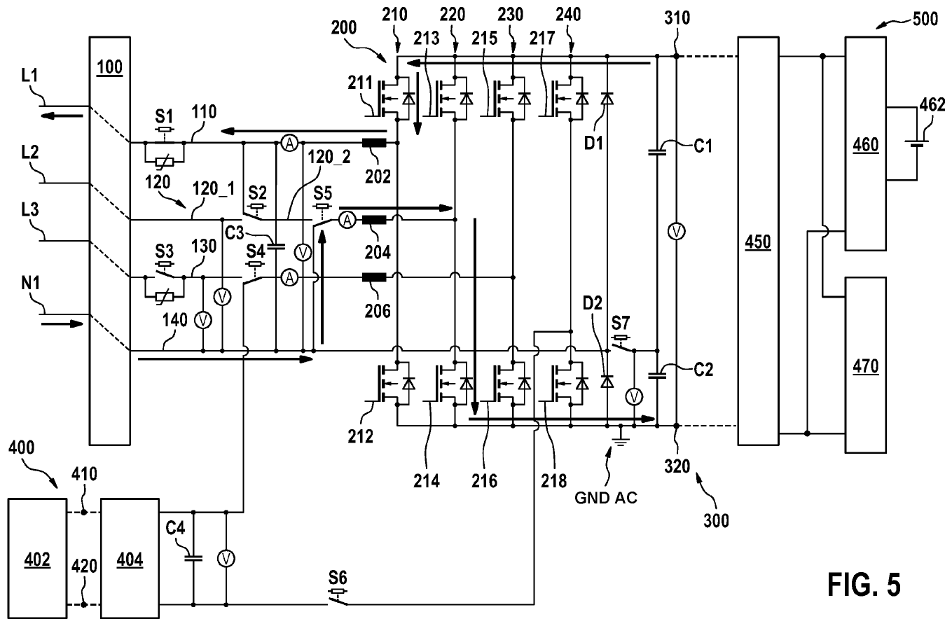

FIG. 5 shows a schematic representation of an exemplary current or energy flow in a third second operation mode of the circuit topology for a charging device. Preferably, to provide electrical energy to the first input terminal L1 and the neutral conductor terminal N1, a direct voltage provided at the positive intermediate terminal 310 and at the negative intermediate terminal 320 is provided at least partially as an alternating voltage at the first input terminal L1 and the neutral conductor terminal 420. Preferably, a current is conducted between the positive intermediate terminal 310 and the first input connector L1 via the first half-bridge 210 and the first throttle 202. The first switching element S1 is preferably closed for this purpose. A current between the negative intermediate terminal 320 and neutral conductor terminal N1 is conducted via the second half-bridge 220 and the second throttle 204, wherein the fifth switching element S5 allows a current flow from the second throttle 204 via the neutral conductor 140 to the neutral conductor terminal N1. Preferably, a third capacitor C3 between the first connecting line 110 and the neutral conductor 140 filters the alternating voltage to be provided in a supporting manner. Preferably, the supplied alternating voltage is provided for supplying domestic loads. Preferably, domestic loads are supplied with an alternating voltage, which, depending on the region, is approximately 120 volts or 230-240 volts. In summary, a provision of electrical energy, a controllable alternating voltage, is enabled at the first input terminal L1 and the neutral conductor terminal N1. This electrical energy is preferably provided by means of a socket outside the vehicle, preferably for supplying other connected, preferably household, loads. The electrical energy at the intermediate terminal 300 is provided by a battery 470 connected for this purpose, preferably via the direct voltage converter 450. For this purpose, the direct voltage converter 450 is configured as a bi-directional direct voltage converter. Preferably, the third operation mode is performed alone or simultaneously with the first operation mode.

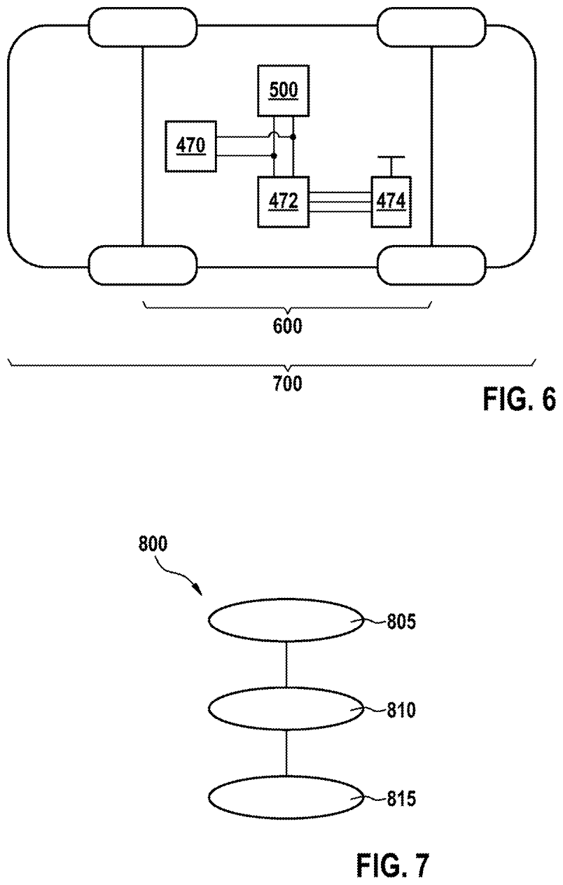

FIG. 6 shows a schematic illustration of a vehicle 700 comprising a drive train 600 with a charging device 500. The vehicle 700 is in this case shown (only by way of example) as comprising four wheels, wherein the invention can be used equally in any vehicle with any desired number of wheels on land, on water, and in the air. The exemplary power train 600 comprises at least one charging device 500. Furthermore, the drive train preferably comprises a battery 470, an inverter 472 and/or or an electric machine 474.

FIG. 7 shows a schematic flow chart for a method 800 for operating a charging device 500. The method 800 starts with step 805. In step 810, the fourth and sixth switching elements S4, S6, as well as the high-side and low-side switches of the third and fourth half-bridges 210, 220, 230, 240, are controlled to provide electrical energy at the bipolar alternating voltage terminal 400. The method ends at step 815.

1. A charging device for a vehicle,
wherein the charging device (500) has an input-side input terminal unit (100) for connecting a single-phase or three-phase alternating voltage, a PFC stage (200) for providing a direct voltage to an intermediate terminal (300), and a bipolar alternating voltage terminal (400) for providing an alternating voltage,
wherein the PFC stage (200) comprises a first (210), a second (220), and a third (230) half-bridge,
wherein the first, second and third half-bridges (210, 220, 230) each comprise a series connection with a high side switch (211, 213, 215) and a low side switch (212, 214, 216),
wherein a center tap between the high side switch and the low side switch of a half-bridge is configured be connected via a first, second and third throttle (202, 204, 206) in each case to a first, second and third input terminal (L1, L2, L3) of the input terminal unit (100) via a first, second and third connecting line (110, 120, 130) in each case,
wherein the half-bridges (210, 220, 230) are connected in parallel and their ends are connected to the intermediate terminal (300), wherein the high side switches are connected to a positive intermediate terminal (310) and the low side switches are connected to a negative intermediate terminal (320),
wherein the charging device comprises a fourth half-bridge (240) connected in parallel to the first, second and third half-bridges (210, 220, 230) with a high side switch (217) and a low side switch (218), wherein a center tap between the high side switch and the low side switch of the fourth half-bridge (240) is switchably connected via a sixth switch element (S6) to a second alternating voltage terminal (420) of the bipolar alternating voltage terminal (400), and
wherein a fourth switching element (S4) is provided, which is configured to establish a connection via the third throttle (206) between the third half-bridge (230) and a first alternating voltage terminal (410) of the bipolar alternating voltage terminal (400) or a connection via the third throttle (206) between the third half-bridge (230) and the third connecting line (130) to the third input terminal (L3).

2. The charging device according to claim 1,
wherein the input terminal unit (100) further comprises a neutral conductor terminal (N1),
wherein a series circuit of a first (D1) and a second (D2) diode is connected in parallel to the half-bridges, wherein the first and second diodes (D1, D2) are switched in the blocking direction and prevent a current flow from the positive intermediate terminal (310) to the negative intermediate terminal (320) and allow a current flow from the negative intermediate terminal (320) to the positive intermediate terminal (310), wherein a center tap between the first and the second diode (D1, D2) is connected to the neutral conductor terminal (N1) via a neutral conductor (140),
wherein a series circuit consisting of a first (C1) and a second (C2) capacitor is connected in parallel to the half-bridges (210, 220, 230),
wherein a fifth switching element (S5) is provided, which is configured to connect the second throttle (204) connected to the second half-bridge (220) on the one hand either to the neutral conductor (140) or to the second connecting line (120) to the second input terminal (L2).

3. The charging device according to claim 2,
wherein the second connecting line (120) divides into a first part of the second connecting line (120_1) and a second part of the second connecting line (120_2),
wherein a second switching element (S2) is provided, which is arranged between the first part of the second connecting line (120_1) and the second part of the second connecting line (120_2), and is configured to conduct a charging current from the second input terminal (L2) via the first part and the second part of the second connecting line (120_1, 120_2) to the second throttle (204) or to conduct a charging current from the first connecting line (110) to the second throttle (204) via the second part of the second connecting line (120_2).

4. The charging device according to claim 1,
wherein a first switching element (S1) is provided and is configured to allow or interrupt a current flow between the first input terminal (L1) and the first connecting line (110).

5. The charging device according to claim 2,
wherein a third switching element (S3) is provided and is configured to allow or interrupt a charging current between the third input terminal (L3) and the third connecting line (130).

6. The charging device according to claim 2,
wherein a seventh switching element (S7) is arranged between the center tap between the first and the second diodes (D1, D2) and a center tap between the first and the second capacitors (C1, C2).

7. The charging device according to claim 1,
wherein a direct voltage provided at the positive intermediate terminal (310) and at the negative intermediate terminal (320) is at least partially provided as alternating voltage at the first alternating voltage terminal (410) and the second alternating voltage terminal (420) in order to provide electrical energy at the bipolar alternating voltage terminal (400),
wherein the fourth switching element (S4) establishes a connection from the center tap of the third half-bridge (230) via the third throttle (206) to the first alternating voltage terminal (410), and the sixth switching element (S6) establishes a connection from the center tap of the fourth half-bridge (240) to the second alternating voltage terminal (420).

8. The charging device according to claim 2,
wherein, to provide electrical energy to the intermediate terminal (300),
either an alternating voltage provided at the input terminal unit 100 via the PFC stage (200) is at least partially provided as direct voltage at the positive intermediate terminal (310) and the negative intermediate terminal (320),
wherein a charging current is conducted via at least the first connecting line (110) and the second connecting line (120), or at least the second part of the second connecting line (120_2), via the PFC stage (200) to the intermediate connection (300) and the entire current flow is preferably fed back via the neutral conductor (140),
or a direct voltage provided by a bi-directional direct voltage converter (550) connected to the intermediate terminal (300) and a battery (560) connected to it is provided at the positive intermediate terminal (310) and at the negative intermediate terminal (320), wherein the bi-directional direct voltage converter converts the voltage of the traction battery to the direct voltage to be provided at the positive intermediate terminal (310) and the negative intermediate terminal (320).

9. The charging device according to claim 2,
wherein the charging device (500) is configured to provide an alternating voltage at the input terminal unit (100) at the first input terminal (L1) and the neutral conductor terminal (N1),
wherein, to provide electrical energy at the first input terminal (L1) and the neutral conductor terminal (N1), a direct voltage provided at the positive intermediate terminal (310) and at the negative intermediate terminal (320) is provided at least partially as alternating voltage at the first input terminal (L1) and the neutral conductor terminal (420),
wherein a current is conducted between the positive intermediate terminal (310) and the first input terminal (L1) via the first throttle (202) and a current is conducted between the negative intermediate terminal (320) and the neutral conductor terminal (N1) via the second throttle (204).

10. A drive train (600) of a vehicle (700) having a charging device (500) according to claim 1, and comprises a traction battery (470), an inverter (472), and/or an electric machine (474).

11. A vehicle (700) having a drive train (600) according to claim 10.

12. A method (800) for operating a charging device according claim 1,
comprising the following step:
controlling (810) the fourth and the sixth switching elements (S4) and (S6) as well as the high-side and low-side switches of the third and fourth half-bridges (210, 220, 230, 240) for providing electrical energy to the bipolar alternating voltage terminal (400).

13. (canceled)

14. A computer-readable storage medium comprising instructions which, when executed by a computer, prompt the latter to operate a charging device (500) that includes
an input-side input terminal unit (100) for connecting a single-phase or three-phase alternating voltage, a PFC stage (200) for providing a direct voltage to an intermediate terminal (300), and a bipolar alternating voltage terminal (400) for providing an alternating voltage,
wherein the PFC stage (200) comprises a first (210), a second (220), and a third (230) half-bridge,
wherein the first, second and third half-bridges (210, 220, 230) each comprise a series connection with a high side switch (211, 213, 215) and a low side switch (212, 214, 216),
wherein a center tap between the high side switch and the low side switch of a half-bridge is configured be connected via a first, second and third throttle (202, 204, 206) in each case to a first, second and third input terminal (L1, L2, L3) of the input terminal unit (100) via a first, second and third connecting line (110, 120, 130) in each case,
wherein the half-bridges (210, 220, 230) are connected in parallel and their ends are connected to the intermediate terminal (300), wherein the high side switches are connected to a positive intermediate terminal (310) and the low side switches are connected to a negative intermediate terminal (320),
wherein the charging device comprises a fourth half-bridge (240) connected in parallel to the first, second and third half-bridges (210, 220, 230) with a high side switch (217) and a low side switch (218), wherein a center tap between the high side switch and the low side switch of the fourth half-bridge (240) is switchably connected via a sixth switch element (S6) to a second alternating voltage terminal (420) of the bipolar alternating voltage terminal (400), and
wherein a fourth switching element (S4) is provided, which is configured to establish a connection via the third throttle (206) between the third half-bridge (230) and a first alternating voltage terminal (410) of the bipolar alternating voltage terminal (400) or a connection via the third throttle (206) between the third half-bridge (230) and the third connecting line (130) to the third input terminal (L3) by:
controlling (810) the fourth and the sixth switching elements (S4) and (S6) as well as the high-side and low-side switches of the third and fourth half-bridges (210, 220, 230, 240) for providing electrical energy to the bipolar alternating voltage terminal (400)
